(19) United States
(12) Patent Application Publication
(10) Pub. No.: US 2026/0356328 A1
(43) Pub. Date: Nov. 12, 2026

(54) DEVICE FOR CLEANING A GLAZED SURFACE

(71) Applicant: VALEO SYSTEMES D'ESSUYAGE, La Verriere (FR)

(72) Inventors: Frederic BRETAGNOL, La Verriere (FR); Matthieu COMBEAU, La Verriere (FR)

(73) Assignee: VALEO SYSTEMES D'ESSUYAGE, La Verriere (FR)

(21) Appl. No.: 19/134,864

(22) PCT Filed: Dec. 11, 2023
(86) PCT No.: PCT/EP2023/085197

§ 371 Date: Jun. 2, 2025

(30) Foreign Application Priority Data
Dec. 14, 2022 (FR) 2213338
Dec. 14, 2022 (FR) 2213339
Dec. 14, 2022 (FR) 2213340

(51) Int. Cl. B60S 1/48; B05B 1/14; B05B 1/16; B05B 1/30; B60S 1/52

(52) U.S. Cl. CPC B60S 1/486; B05B 1/1422; B05B 1/169; B05B 1/3006; B60S 1/52

(57) ABSTRACT

The invention proposes a cleaning device for a glazed surface of a detection device fitted to a vehicle. The cleaning device includes a nozzle supplied with liquid cleaning product, and having a spray head diffusing the liquid in the form of a jet. The spray head having a closed end. The spray head includes at least one spray wall provided with at least one hole through which a straight jet exits.

### TECHNICAL FIELD

The present invention relates to the field of driving assistance devices and, more particularly, to the field of optical detection systems used for this purpose.

The invention relates more particularly to the cleaning devices which are configured to clean an optical sensor of such an optical detection system.

### BACKGROUND OF THE INVENTION

Optical detection system is the name given to any system including optical sensors, such as cameras, laser sensors or other sensors based on the emission and/or the detection of light in the spectrum visible or invisible to humans, in particular the infrared.

Such optical detection systems are being fitted to an increasingly large number of motor vehicles in order either to assist the driver of the vehicle in certain driving situations, one well known example of which is parking assistance, or to make the vehicle self-driving or at least partially self-driving.

Driving assistance devices may include detection devices which may take the form, for example, of sensors intended to assess an environment outside the motor vehicle, or the form of a camera intended to provide the driver with visibility of an environment outside the motor vehicle, visually inaccessible from the driver's seat. Such detection devices then comprise at least one glazed surface positioned within the vehicle such that it is capable of capturing the environment outside the motor vehicle, in a desired area.

In order for the self-driving feature and/or the driving assistance to be as effective as possible, the data supplied by the sensor must be of the best possible quality, and it is therefore essential to have a clean glazed surface to acquire these data.

In order to achieve this, a cleaning device is arranged in the vicinity of an optical detection device (for example the lens of an image-capturing camera) so that a fluid can be sprayed, on demand, in order to remove any dirt that has become deposited on the glazed surface of the detection device. This may be dust or insects, for example.

This cleaning is essential to provide optimal visibility to the sensor or the user of the motor vehicle.

It is known practice for such a cleaning device to comprise a nozzle hydraulically connected to a fluid storage tank. The fluid is ejected from the nozzle via a dispensing port, toward the glazed surface to be cleaned. The nozzle sprays the cleaning liquid in the form of a jet.

During operation, the free end of the nozzle protrudes from the body and is therefore visible from outside said vehicle.

It is known practice to use nozzles with a relatively wide jet profile, such as a flat jet or conical jet, making it possible to have a large radius of action, sweep the entire width of the glazing, and therefore clean a large surface area, in this case the entire glazed surface of the sensor to be cleaned, with a single dispensing port.

The flat jet consists of a jet that strikes orthogonally or obliquely on a deflection surface that allows the jet to be reflected flat and with a large width, like a fan.

The conical jet exits from the cleaning device with a solid or hollow conical shape.

It is therefore possible to clean the entire surface in question using a single jet and a single nozzle. The use of a single nozzle allows discreet operation, avoiding too many visible parts protruding from the vehicle body.

The disadvantage of this type of nozzle with a flat or conical jet is that it uses an excessive volume of cleaning liquid. Moreover, the width of the jet required to sweep the entire glazed surface to be cleaned leads to a reduction in impact pressure, which results in a reduction in cleaning efficiency.

There is currently a problem to be addressed, as it is sought to reduce the amount of cleaning fluid used, in order to carry a smaller volume of liquid on board the vehicle, and to avoid wasting the liquid on board.

### SUMMARY OF THE INVENTION

The aim of the present invention is therefore to provide a cleaning device that can be discreet and compact and that uses a smaller amount of cleaning liquid, while offering high cleaning performance.

The invention therefore relates to a cleaning device for a glazed surface of a detection device fitted to a vehicle, comprising a nozzle supplied with liquid cleaning product, and having a spray head diffusing the liquid in the form of a jet, said spray head having a closed end.

The invention is mainly characterized in that said spray head comprises at least one spray wall provided with at least one hole through which a straight jet exits.

The detection device and the cleaning device may be those of a driving assistance device housed within a motor vehicle. For example, the detection device may be a camera or a sensor making it possible to enhance visibility of the environment outside the motor vehicle for a user of said vehicle. Each camera or each sensor has at least one glazed surface exposed to the external environment. By virtue of its glazed surface, the detection device captures data from the environment outside the motor vehicle. The cleaning device allows the glazed surface of the detection device to be cleaned in such a way that external pollutants are removed from said glazed surface and thus its optical performance is not impaired.

The cleaning device according to the invention cleans the glazed surface with a straight jet. This means that the jet that strikes a surface forms a point on the surface. This point has a very small section, unlike flat and conical jets which have very wide sections.

The idea underlying the invention is to use this form of straight jet, also referred to as a “straight point”, to have a stronger point of impact on the glazed surface, making it possible to remove stubborn dirt more effectively, for a constant flow rate through the nozzle. To be specific, the fluid speed is higher than in the prior art, because the passage section of the hole is smaller, for the same flow rate. The effectiveness of the cleaning is thus improved.

The number of holes should be defined according to the surface to be cleaned.

Each hole forms a straight jet at the outlet. Together, these straight jets cover the entire glazed surface to be cleaned.

By thus using one or more holes with a straight jet profile, the quantity of liquid cleaning product to be used is drastically reduced, while still having a conventional cleaning device, in particular with a pump, a valve, a fluid circulation channel inside the nozzle, etc. Only the spray head differs. It is more compact because the holes are very small compared to the prior art. The part protruding from the vehicle body is therefore minimal.

According to the various embodiments of the invention, which may be taken together or separately:
the hole has a diameter of between 50 and 250 μm. By way of comparison, a hole for a conical jet has a diameter of between 0.3 and 1 mm.
the spray wall has a plurality of holes distributed spatially such that their jets cover most of the glazed surface to be cleaned, located opposite.
the spray wall has a plurality of holes distributed uniformly.
all of the holes have the same section.
the spray wall is oriented perpendicular or obliquely to the closed end.
the closed end consists of a spray wall.
the hole is cylindrical.
the spray wall is flat.
the spray wall is curved.
all of the holes are oriented perpendicular to the spray wall, the resulting straight jets being perpendicular to the spray wall.
all of the holes are oriented obliquely to the spray wall, the resulting straight jets being oblique to the spray wall.
some of the holes are oriented perpendicular to the spray wall, and the other holes are oriented obliquely to the spray wall.

According to a variant embodiment,
said spray head comprises at least one spray wall provided with at least a first type of hole through which an impact jet exits, and at least a second type of hole through which a rinsing jet exits, the section of the hole of the first type being smaller than the section of the hole of the second type, the maximum diameter of the holes of the second type being less than 250 μm.
the cleaning device cleans the glazed surface using two types of holes, forming two types of jet at the outlet.
the first type of hole, the section of which is very small, makes it possible to have, at the outlet, a more targeted jet with a high impact, in other words with strong pressure on the glazed surface. This type of jet is used to remove stubborn dirt from the glazed surface.
the second type of hole, the section of which is small, but slightly larger than the section of the first type of hole, makes it possible to have, at the outlet, a less targeted, wider jet, with a lower impact but greater surface rinsing power. This jet is used to rinse the glazed surface, for example to remove dust.
the combination of these two types of holes allows efficient cleaning of the glazed surface. The effectiveness of the cleaning is thus improved.
the flow rate of liquid passing through a hole of the first type is lower than the flow rate of liquid passing through a hole of the second type, because the fluid passage section of a hole of the first type is smaller than the passage section of a hole of the second type, for the same fluid speed.

Thus, it will be appreciated that the second type of hole ensures cleaning that is less impactful but with greater rinsing power thanks to its higher flow rate.
the number of holes should be defined according to the surface to be cleaned. Together, the jets exiting from the nozzle must cover the entire glazed surface to be cleaned.
these holes of the first type and second type have a diameter of less than 250 μm, whereas in the prior art a dispensing port has a diameter of the order of 0.3 mm to 1 mm.
by thus using these small holes of the first type and second type, the quantity of liquid cleaning product to be used is drastically reduced, while still having a conventional cleaning device, in particular with a pump, a valve, a fluid circulation channel inside the nozzle, etc. Only the spray head differs. It is more compact because the holes are very small compared to the prior art. The part protruding from the vehicle body is therefore minimal.
each jet is straight: this means that the jet that strikes a surface forms a point on the surface. This point has a very small section, unlike flat and conical jets which have very wide sections. The idea is to use this form of straight jet, also referred to as a “straight point”, to have a stronger point of impact on the glazed surface, making it possible to remove stubborn dirt even more effectively, both for the holes of the first type and the holes of the second type.
the spray wall has a plurality of holes of the first type distributed spatially on the spray wall such that their jets strike various areas of the glazed surface located opposite.
the spray wall has a single hole of the second type arranged on the spray wall in such a way as to rinse the glazed surface located opposite.
the hole of the first type is cylindrical and has a diameter equal to or less than 150 μm.
the hole of the second type is cylindrical and has a diameter greater than 150 μm and less than or equal to 250 μm.
the flow rate of liquid passing through a hole of the first type is lower than the flow rate of liquid passing through a hole of the second type.
the nozzle has a single liquid circulation channel, the liquid exiting simultaneously through the first and second types of holes.
the nozzle has a first liquid circulation channel opening into the hole(s) of the first type, and a second liquid circulation channel opening into the hole(s) of the second type, said first and second channels being connected to a valve such that the liquid exits either through the hole(s) of the first type, or through the hole(s) of the second type.
all of the holes are oriented perpendicular to the spray wall, the resulting straight jets being perpendicular to the spray wall.
all of the holes are oriented obliquely to the spray wall, the resulting straight jets being oblique to the spray wall.
some of the holes are oriented perpendicular to the spray wall, and the other holes are oriented obliquely to the spray wall.

According to another variant embodiment,
said spray head comprises at least one spray wall provided with holes through which jets exit, these holes being distributed in groups, each group comprising one or more holes from which the jets reach a predefined area of the vehicle, the nozzle having as many liquid circulation channels as there are groups, each channel opening into a group of hole(s), said channels being connected to valves allowing the passage of liquid selectively through a single channel or through several channels.
the cleaning device cleans the glazed surface using several holes distributed in several groups.
thus, there is no longer a single dispensing port as in the prior art, but there is a plurality of dispensing ports, in other words holes, and thus a plurality of jets.
the holes are distributed in groups, in order to concentrate the jets of the same group on a predefined area of the vehicle. There are therefore several groups cleaning several areas.
Thus, several areas of the vehicle can be cleaned at the same time, with a single spray wall.
by virtue of the valves and the various channels within the nozzle, it is possible to send liquid through only a single group of hole(s) in order to clean a single predefined area of the vehicle, and thus avoid wasting liquid by sending jets through the other groups.

For example, if only one area of the glazed surface of the detection device needs to be cleaned, the other areas being clean, liquid will only be sent through the channel associated with the group of hole(s) from which the jet is directed toward that specific area to be cleaned. The other areas will not be cleaned.

It is possible to choose to send liquid through one or more channels, depending on the areas to be cleaned.

The use of several groups of holes and several channels is also advantageous for adapting to weather conditions outside the vehicle. For example, a first group of hole(s) may have one or more jet(s) directed toward the glazed surface to be cleaned, and a second group of hole(s) may have one or more jet(s) directed toward an area of the vehicle adjacent to the glazed surface to be cleaned. If the vehicle is not moving fast, then the first group may be activated via a first channel and its associated valve to send a jet directly toward the glazed surface. If the vehicle is moving fast or it is windy, then the second group may be activated via a second channel and its associated valve to send a jet toward the adjacent area, but this jet will be deflected by the wind or by the aerodynamic flow toward the glazed surface to be cleaned.

According to this other variant embodiment,
the holes are cylindrical.
the holes have a diameter of less than 300 μm.
the holes have a diameter of between 50 μm and 250 μm.
the valves are connected to a pump, the device comprising a central unit controlling the pump and/or the valves according to input data, such as vehicle speed or outside temperature.
for each group, each hole has a specific angular orientation relative to the spray wall, such that when the jet exits it reaches the predefined area on the vehicle.
each group of hole(s) forms one or more jet(s) capable of striking an area of the glazed surface, the spray wall comprising as many groups of hole(s) as there are areas to be struck on the glazed surface.
each jet is straight.

### BRIEF DESCRIPTION OF DRAWINGS

Further features and advantages of the invention will become apparent from reading the following detailed description, for an understanding of which reference will be made to the appended drawings, in which:

FIG. 1 shows the projection of several different jet shapes;

FIG. 2 is a perspective view of a nozzle according to the prior art diffusing a flat jet;

FIG. 3a is a perspective view of a nozzle according to the invention with a first spray head configuration;

FIG. 3b is a perspective view of a nozzle according to a first variant of the invention with a first spray head configuration;

FIG. 4a is a perspective view of a nozzle according to the invention with a second spray head configuration;

FIG. 4b is a perspective view of a nozzle according to the first variant of the invention with a second spray head configuration;

FIG. 5a is a perspective view of a nozzle according to the invention with a third spray head configuration;

FIG. 5b shows several possible arrangements of holes according to the first variant of the invention;

FIG. 6 shows the projection of a straight jet from a nozzle according to the invention;

FIG. 7a is a sectional view of an example of the spray head of a nozzle according to one of FIG. 3a to FIG. 5a;

FIG. 7b is a sectional view of an example of the spray head of a nozzle according to one of FIG. 3b to FIG. 5b;

FIG. 8 is a sectional view of another example of the spray head of a nozzle according to one of FIG. 3 to FIG. 5;

FIG. 9a is a detailed view of the holes present on a spray head of a nozzle according to the invention;

FIG. 9b is a detailed view of the holes present on a spray head of a nozzle according to the first variant of the invention;

FIG. 10a is a perspective view of a nozzle according to the invention with a fourth spray head configuration;

FIG. 10b is a perspective view of a nozzle according to the first variant of the invention with a fourth spray head configuration;

FIG. 11a is a sectional view of an example of the spray head of a nozzle according to FIG. 10a;

FIG. 11b is a sectional view of an example of the spray head of a nozzle according to FIG. 10b;

FIG. 12a is a perspective view of a nozzle according to the invention with a fifth spray head configuration;

FIG. 12b is a perspective view of a nozzle according to the first variant of the invention with a fifth spray head configuration;

FIG. 13a is a perspective view of a nozzle according to the invention with a sixth spray head configuration;

FIG. 13b is a perspective view of a nozzle according to the first variant of the invention with a sixth spray head configuration;

FIG. 14 is a graph comparing the performance of a prior art nozzle with a nozzle according to the invention.

FIG. 15 is a perspective view of a nozzle according to a second variant of the invention;

FIG. 16 perspective and transparent view of the channels inside the nozzle of FIG. 15;

FIG. 17 is a schematic view of a hydraulic cleaning circuit according to a first configuration of the second variant of the invention; and

FIG. 18 is a schematic view of a hydraulic cleaning circuit according to a second configuration of the second variant of the invention.

### DETAILED DESCRIPTION OF THE INVENTION

In the rest of the description, elements having an identical structure or similar functions will be denoted by the same references.

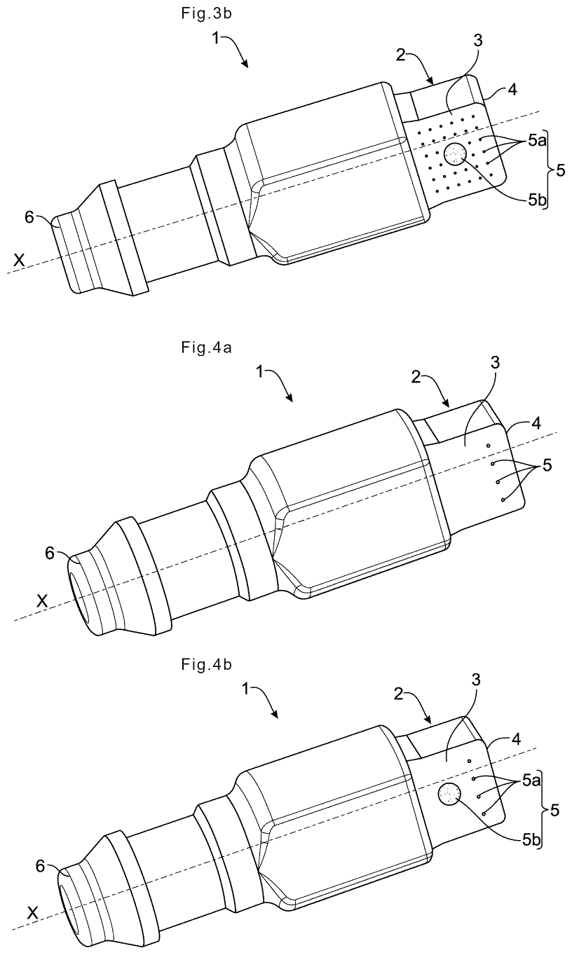

By convention, the “axial” direction corresponds to the main direction of extension of the nozzle, illustrated by the axis X in FIGS. 3a and 3b, and the “radial” direction is orthogonal to the axial direction. For example, the axis Y is orthogonal to the axis X and thus indicates a radial direction.

In the detailed description of the figures below, the terms “upper” and “lower” or “top” and “bottom” will be used with reference to the axial direction without any limitation being intended.

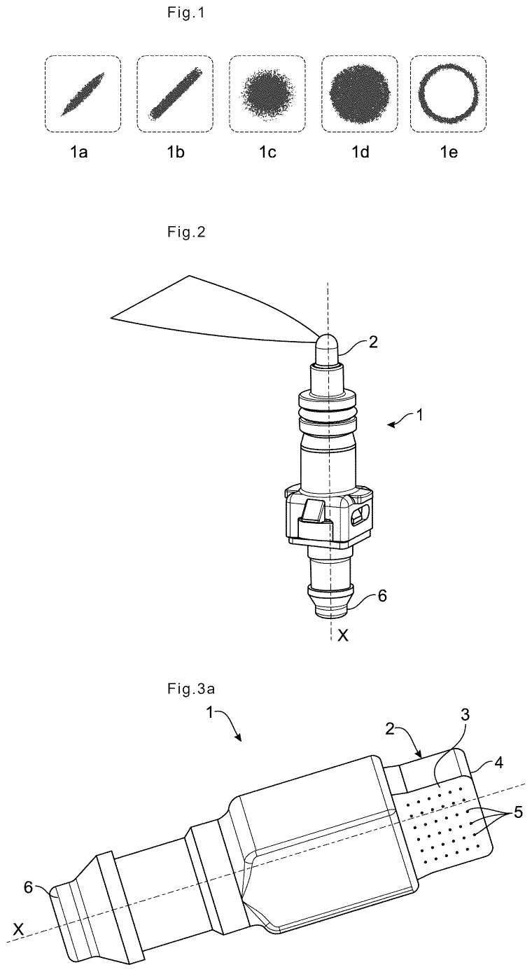

FIG. 1 shows the projection of several different jet shapes.

In this instance, depictions 1a and 1b show the projection of a flat jet. The flat jet shown in depiction 1a has a convex distribution, while the flat jet shown in depiction 1b has a uniform distribution.

Depictions 1c, 1d and 1e show the projection of a conical jet. This conical jet has a convex distribution in depiction 1c, a uniform distribution in depiction 1d, and a concave distribution in depiction 1e.

These types of flat and conical jets are used in prior art cleaning devices to clean the glazed surface of various optical sensors belonging to detection systems installed on motor vehicles.

Such a prior art cleaning device is shown in FIG. 2. In this case, it is a nozzle 1 hydraulically connected to a source for supplying cleaning product.

The cleaning product is a fluid, preferably in liquid form, such as windshield washer fluid. In general, a pump takes the liquid product from the supply source (in this case a tank) and sends it, via one or more valves, to the nozzle 1 which then diffuses the liquid product in the form of a jet toward the optical sensor located nearby.

The nozzle 1 has a first end 6 corresponding to a hydraulic connection, and a second free end corresponding to a spray head 2 through which the liquid product is expelled. In this case, the liquid product is sprayed in the form of a flat jet with a uniform distribution.

The nozzle 1 extends along a central axis X, from the first end 6 to the spray head 2. The nozzle 1 has an internal channel inside which the liquid product circulates from the first end 6 to the spray head 2.

The spray head 2 is closed and has a port for dispensing the liquid product to diffuse it in the form of a jet, after it has been reflected on a deflection surface located inside the head 2, in such a way as to obtain a flat jet.

For flat and conical jets, the single dispensing port must be large enough to provide a wide spray at the outlet, of the order of 0.3 mm to 1 mm in diameter.

For conical jets, the dispensing port must have a particular shape, for example with a first cylindrical portion followed by a second conical portion flared outward. It is also possible to provide a swirl chamber inside the spray head opening onto the dispensing port. It is also possible to provide a spout in the spray head, with an anvil arranged inside, in such a way as to form a jet with a certain shape at the outlet. There are many technical solutions.

These flat and conical jets have the advantage of being able to diffuse product with a relatively broad span, and therefore of covering at least the entire width of the glazed surfaces of the sensors.

However, the pressure of the liquid product on the glazed surface at the time of impact is sometimes not sufficient to remove the most stubborn stains.

Hence the use of the nozzles 1 according to the invention as shown in FIG. 3a to FIG. 13b. In these figures, the nozzle 1 used retains all of the technical features of the prior art nozzle 1, except for the spray head 2.

The spray head 2 is still closed by means of a closed end 4, but it is considerably simplified. In particular, it does not have an internal deflection surface, or a spout, or an anvil, or a dispensing port with a complex shape or large diameter.

The spray head 2 according to the invention comprises at least one spray wall 3 provided with at least one hole 5 through which a straight jet exits.

This is a simple hole 5, with a uniform section.

The jet is straight, meaning that its projection corresponds only to a point, as shown in FIG. 6.

Such a straight jet cannot sweep the entire width of a glazed surface of a detection device, unless the glazed surface is very small. However, with such a straight jet, the pressure is greater at the point of impact, compared to a conical or flat jet. This type of straight jet therefore allows for better cleaning of dirty surfaces at the precise location where it strikes.

The spray wall 3 is oriented toward the detection device to be cleaned located near the nozzle 1.

According to the invention, each hole 5 has a diameter of between 50 and 250 μm, which is very small compared to the diameter of the dispensing ports of the prior art. This also allows for precision regarding the point of impact on the surface to be cleaned.

To cover a larger surface area, several holes 5 may be provided in the spray wall 3, in order to distribute the jets over the surface to be cleaned. Preferably, the holes 5 are distributed spatially on the spray wall 3 such that their jets cover most of the glazed surface to be cleaned, located opposite.

The number of holes 5 to be provided is calculated on the basis of the extent of the surface to be cleaned nearby.

Preferably, the holes 5 are so small that the sum of their sections is still smaller than the section of a dispensing port according to the prior art.

Thus, for the same flow rate passing through the nozzle 1, the pressure of the jet on the glazed surface will be significantly greater with a spray head 2 according to the invention, than with a spray head 2 according to the prior art.

This is shown in particular in FIG. 14, in which the curve with the small circles corresponds to the use of a nozzle 1 according to the prior art, and the curve with the small diamonds corresponds to the use of a nozzle 1 according to the invention. For the same flow rate (in ml/s), the pressure exerted on the surface to be cleaned by the jet exiting from a nozzle 1 according to the prior art is much lower than the pressure exerted on the same surface to be cleaned by the jet exiting from a nozzle 1 according to the invention.

This is because the smaller the passage section of the hole, the more the fluid speed increases for the same volume flow rate. By virtue of this higher fluid speed (i.e. the speed of interaction with the surface), cleaning efficiency is improved.

With these small holes, it follows that the consumption of liquid product required for cleaning is lower compared to the prior art. In fact, consumption drops by at least 40%, and up to 60% with a nozzle according to the invention compared to a nozzle according to the prior art, while maintaining the same percentage of coverage of the cleaned surface, as shown in the table below.

Std nozzle corresponds to a nozzle according to the prior art.

New nozzle corresponds to a nozzle according to the invention.

The first column states the percentage of the surface covered by the jets.

The second column states the windshield washer liquid consumption in ml/s.

The third column compares the liquid consumption between the two types of nozzle, and gives the percentage liquid used with the nozzle according to the invention. The drop is around 60%.

The fourth column states the speed of the fluid at the outlet of the port/hole.

The fifth column compares the speed of the fluid between the two types of nozzle, and gives the percentage additional speed with the nozzle according to the invention. There is an increase in speed of around 17% to 20%.

| | | Windshield | consumption | | speed |
|---|---|---|---|---|---|
| | | washer liquid | % gain new | Fluid speed | % gain new |
| | % | consumption | nozzle versus | at port outlet | nozzle versus |
| | cleaning | measured | std nozzle | (m/s) | std nozzle |
| Std nozzle @ 1.5 bar | 75 | 6.5 | / | 10.2 | / |
| New nozzle @ 1.5 bar | 90 | 2.7 | 41.5 | 12.3 | 120.6 |
| Std nozzle @ 2.4 bar | 99 | 8.2 | / | 12.8 | / |
| New nozzle @ 2.4 bar | 99 | 3.3 | 40.2 | 15 | 117.2 |
| Std nozzle @ 4 bar | 99 | 10.6 | / | 16.6 | / |
| New nozzle @ 4 bar | 99 | 4.3 | 40.6 | 19.6 | 118.1 |

According to a first configuration of the spray head 2 shown in FIG. 3a, the spray wall 3 has a plurality of holes 5 distributed uniformly. In this case, there are 36 holes 5 distributed over six columns oriented perpendicular to the axis X, each column comprising six holes 5. Each hole 5 has a diameter of 100 μm.

According to a second configuration of the spray head 2 shown in FIG. 4a, the spray wall 3 has four holes 5 aligned in a single column oriented perpendicular to the axis X. Each hole 5 has a diameter of 200 μm.

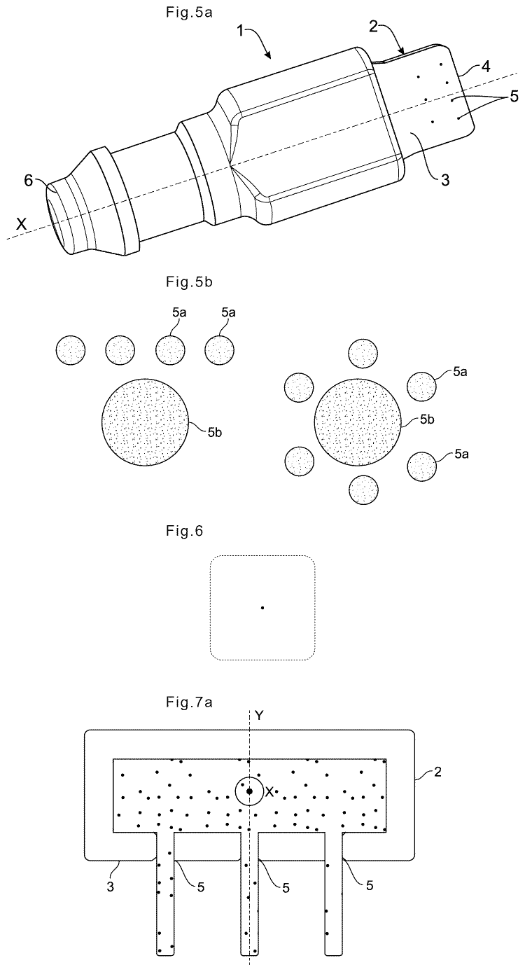

According to a third configuration of the spray head 2 shown in FIG. 5a, the spray wall 3 has seven holes 5 aligned in two columns oriented perpendicular to the axis X. The holes 5 are staggered from one column to another.

Preferably, whatever the configuration, the holes 5 have the same section.

However, within the framework of the present invention, it would be possible to provide that the holes 5 not have the same section depending on their location on the spray wall 3.

It will be appreciated that there may be a multitude of possible configurations, depending on the number of holes 5, their section, and their position on the spray wall 3.

Note that the holes 5 are preferably arranged in the vicinity of the closed end 4 of the spray head 2. This is because only the spray head 2 protrudes from the vehicle body. The closer the holes 5 are to the closed end 4, the more it will be possible to hide part of the spray head 2 in the body. This applies to fixed nozzles in the body. The nozzles of the present invention may also be removable, in particular movable by translation, or telescopic in order to disappear under the hood.

In FIG. 3a to FIG. 5b, the spray walls are oriented perpendicular to the closed end 4. However, within the framework of the present invention, it would be possible to provide spray walls oriented obliquely to the closed end 4, i.e. inclined relative to the axis X. The orientation of the spray wall 3 depends in particular on its position relative to the surface to be cleaned.

In the three examples shown in FIG. 3a to FIG. 5b, the spray head 2 has a rectangular section. It is therefore formed of four side walls and an end wall.

Depending on the position of the nozzle 1 relative to the glazed surface to be cleaned of the detection device, the holes 5 will be made on one of these five walls. To be specific, it is possible to envisage making holes 5 on the end wall if this is more practical for the integration of the nozzle 1 in relation to the detection device within the body. Thus, the end wall may also correspond to a spray wall 3.

It is also possible to envisage making holes 5 on several walls of the same nozzle 1, in order to be able to simultaneously or alternately clean several glazed surfaces belonging to several detection devices which are located near this nozzle 1. In this case, the spray head 2 has several spray walls 3.

It is possible to envisage having several channels inside the nozzle 1 in order to be able to send liquid selectively to one or the other spray wall 3 depending on the sensor to be cleaned nearby.

According to a variant embodiment shown in FIG. 3b, the spray head 2 no longer has a single outlet port, but at least two outlet ports or holes 5 of different types, referred to as the first type of hole 5a, and second type of hole 5b.

These two types of holes 5a, 5b are located on the same spray wall 3.

The spray head 2 comprises at least one spray wall 3. The spray wall 3 is oriented toward the detection device to be cleaned located near the nozzle 1.

The spray head 2 could comprise several spray walls 3 if there are several glazed surfaces to be cleaned.

The first type of hole 5a allows the exit of an impact jet.

The second type of hole 5b allows the exit of a rinsing jet.

The section of the holes of the first type 5a and of the second type 5b is smaller than 0.15 mm2, which is very small compared to the prior art.

Thus, instead of having a single jet that must cover the entire glazed surface, there are several jets that reach several areas of the glazed surface, so that ultimately cleaning fluid is spread over the entire surface.

The section of the hole of the first type 5a is smaller than the section of the hole of the second type 5b.

The smaller the passage section of the hole 5, the more the fluid speed increases for the same volume flow rate. By virtue of this higher fluid speed (i.e. the speed of interaction with the surface), the impact pressure will be greater at the point of impact on the glazed surface, compared to the prior art. Thus, the holes of the first type 5a are mainly used to strike the glazed surface with a strong impact at several points, in order to remove stubborn stains.

As for the holes of the second type 5b, these rinse the surface, with less impact.

The combination of the two types of holes 5a, 5b makes it possible to improve cleaning efficiency.

The holes 5 (of the first type and second type) are simple, with a uniform section.

Preferably, the holes 5 are cylindrical. However, they could have a square or rectangular section.

These simple holes 5 make it possible to obtain a straight jet at the outlet, meaning that its projection corresponds only to a point, as shown in FIG. 6.

According to this variant embodiment, the holes of the first type 5a have a diameter equal to or less than 150 μm. This also allows for precision regarding the point of impact on the surface to be cleaned.

For example, the holes of the first type 5a have a diameter of 50 μm.

The holes of the second type 5b have a diameter of greater than 150 μm and less than 250 μm.

The number of holes of the first type 5a to be provided is calculated on the basis of the extent of the surface to be cleaned nearby.

In addition, there is at least one hole of the second type 5b in the spray wall 3. This hole of the second type 5b is arranged on the spray wall 3 such that its jet reaches the glazed surface, rinsing it by spreading the fluid over the surface. The orientation of the jet is therefore important to ensure spreading over the entire surface after impact.

The holes of the first type 5a and of the second type 5b are so small that the sum of their sections is still smaller than the section of a dispensing port according to the prior art.

The smaller the passage section of the hole, the more the fluid speed increases for the same volume flow rate. By virtue of this higher fluid speed (i.e. the speed of interaction with the surface), cleaning efficiency is improved.

According to a first configuration of the spray head 2 shown in FIG. 3b, the spray wall 3 has a plurality of holes of the first type 5a distributed uniformly. In this case, there are 32 holes 5a distributed over six columns and six rows. The spray wall 3 also has a hole of the second type 5b positioned at the center. All of the holes are cylindrical.

According to a second configuration of the spray head 2 shown in FIG. 4b, the spray wall 3 has four holes of the first type 5a aligned in a single column oriented perpendicular to the axis X, and a hole of the second type 5b positioned under the holes of the first type 5a. All of the holes are cylindrical.

FIG. 5b (on the left) shows more specifically this distribution of the holes 5 of FIG. 4b.

FIG. 5b (on the right) shows another possible spatial representation of the holes, with a single planetary hole of the second type 5b (at the center), and six satellite holes of the first type 5a (on the periphery). In this example, the holes of the first type 5a have a diameter of 100 μm, and the hole of the second type 5b has a diameter of 250 μm. All of the holes are cylindrical.

In the spray wall 3, the flow rate passing through a hole of the first type 5a is logically reduced compared to the flow rate passing through a hole of the second type 5b, but the jet exiting a hole of the first type 5a has a point of greater impact. The hole of the second type therefore has a higher flow rate, but with less impact, and thus ensures the general rinsing of the glazed surface.

It will be appreciated that there may be a multitude of possible configurations, depending on the number of holes 5a and 5b, their section, and their position on the spray wall 3.

Preferably, the holes 5 are arranged in the vicinity of the closed end 4 of the spray head 2. This is because only the spray head 2 protrudes from the vehicle body. The closer the holes 5 are to the closed end 4, the more it will be possible to hide part of the spray head 2 in the body. This applies to fixed nozzles in the body. The nozzles of the present invention may also be removable, in particular movable by translation, or telescopic in order to disappear under the hood.

In FIGS. 3b and 4b, the spray walls are oriented perpendicular to the closed end 4. However, within the framework of the present invention, it would be possible to provide spray walls oriented obliquely to the closed end 4, i.e. inclined relative to the axis X. The orientation of the spray wall 3 depends in particular on its position relative to the surface to be cleaned.

In the two examples shown in FIGS. 3b and 4b, the spray head 2 has a rectangular section. It is therefore formed of four side walls and an end wall.

Depending on the position of the nozzle 1 relative to the glazed surface to be cleaned of the detection device, the holes 5 will be made on one of these five walls. To be specific, it is possible to envisage making holes 5 on the end wall if this is more practical for the integration of the nozzle 1 in relation to the detection device within the body. Thus, the end wall may also correspond to a spray wall 3.

It is also possible to envisage making holes 5 on several walls of the same nozzle 1, in order to be able to simultaneously or alternately clean several glazed surfaces belonging to several detection devices which are located near this nozzle 1. In this case, the spray head 2 has several spray walls 3.

It is possible to envisage having several channels inside the nozzle 1 in order to:
be able to send liquid selectively to one or the other spray wall 3 depending on the sensor to be cleaned nearby;
be able to send liquid selectively to the holes of the first type 5a of a spray wall 3, or to the holes of the second type 5b of this same spray wall 3.

A valve upstream of the nozzle manages the sending of liquid to the various channels.

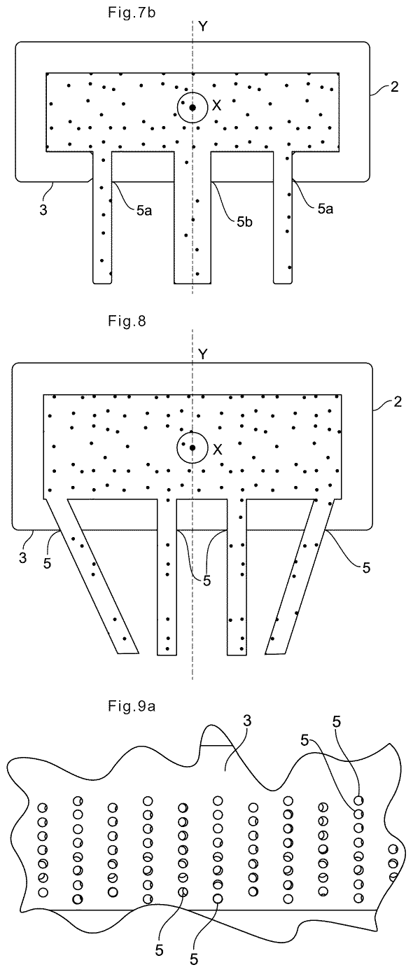

FIGS. 7a, 7b, and 8 show a sectional view of these spray heads 2 with a rectangular section. These sectional views show some holes 5 through which liquid product exits in the form of a straight jet.

Generally, in all of the configurations shown in FIG. 3a to FIG. 13b, the holes 5 are cylindrical, or nearly cylindrical. In most manufacturing processes, the holes are almost cylindrical, but are flared out a little into a cone shape.

In the figures shown, the cylindrical holes have a circular section at the outlet.

However, within the framework of the present invention, the cylindrical holes could have a square, or rectangular, or other section.

Note that in FIGS. 7a and 7b, the holes 5 are oriented perpendicular to the spray wall 3.

In FIG. 8, the two central holes 5 are oriented perpendicular to the spray wall 3, while the two lateral holes 5 are oriented obliquely to the spray wall 3.

When the holes 5 are oriented perpendicular to the spray wall 3, the resulting straight jets are perpendicular to the spray wall 3.

When the holes 5 are oriented obliquely to the spray wall 3, the resulting straight jets are oblique to the spray wall 3.

This applies both to the holes of the first type 5a and the holes of the second type 5b.

Depending on the case, all of the holes 5 may be oriented perpendicular to the spray wall 3, or only some of them, or all of the holes 5 may be oriented obliquely to the spray wall 3, or only some of them.

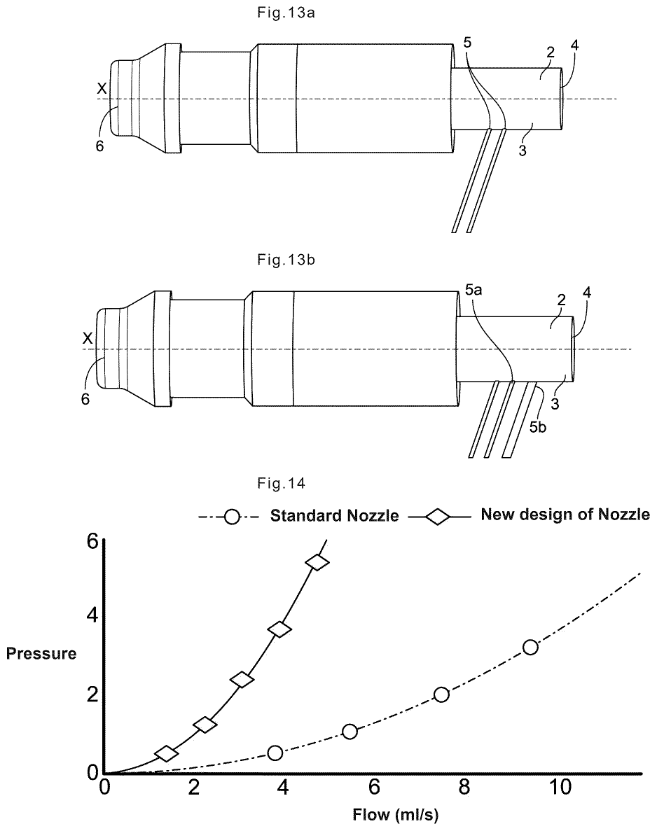

The obliquely oriented holes 5 may be oriented inward as in FIG. 8 (i.e. toward the axis Y), or outward as in FIG. 12a to FIG. 12b (i.e. away from the axis Y), or rearward as shown in FIGS. 13a and 13b (i.e. toward the first end 6 of the nozzle 1), or forward (i.e. toward the second end 4 of the nozzle 1), and moreover in combination.

The angles are chosen as a function of the area to be treated by the jet on the surface to be cleaned.

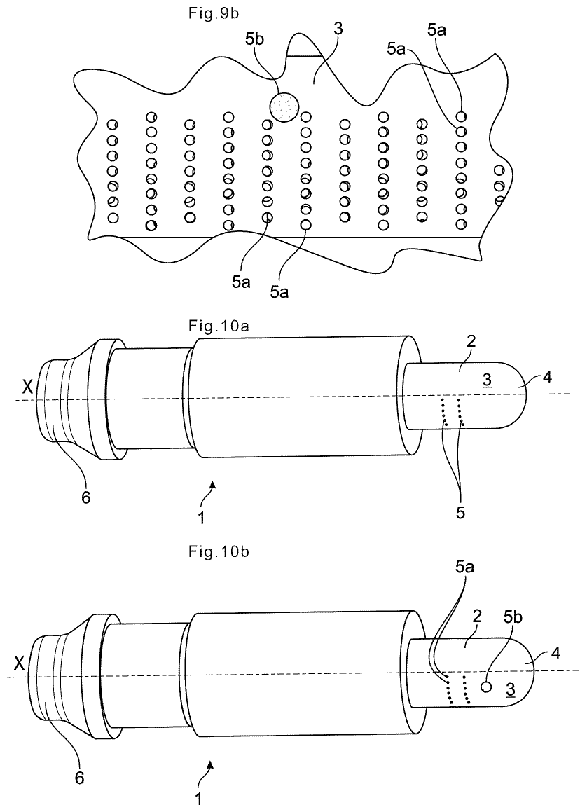

FIGS. 9a and 9b show an enlarged view of a spray wall 3 with a plurality of holes 5 of cylindrical section, each hole 5 having a specific orientation, defined according to the surface to be cleaned located nearby, in such a way as to ensure the jets are directed toward precise locations on the surface.

In FIG. 3a to FIGS. 5b, and 7 to 8, the spray wall 3 is flat.

However, the spray wall 3 could be curved, as shown in FIG. 10a to FIG. 13b.

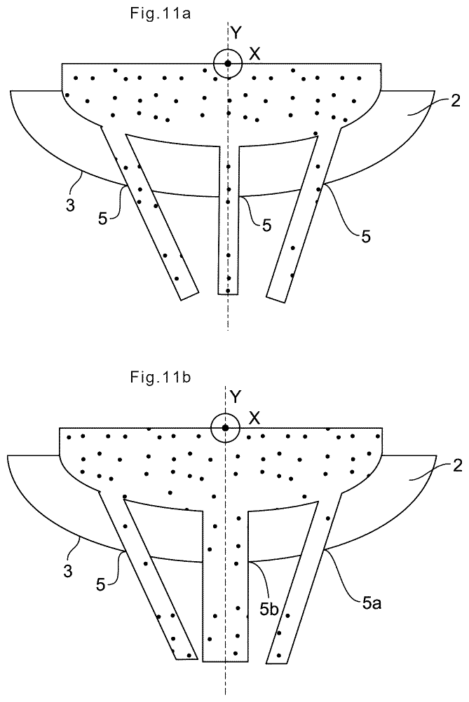

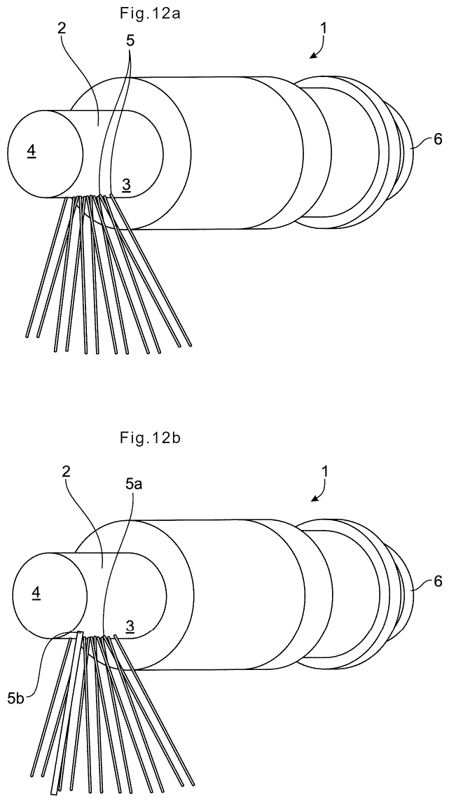

In particular in FIG. 11a and FIG. 11b, showing a sectional view of part of the section of the spray head 2 of FIG. 10a and FIG. 10b, the curved shape of the spray wall 3 in which the holes 5 are made can be clearly seen.

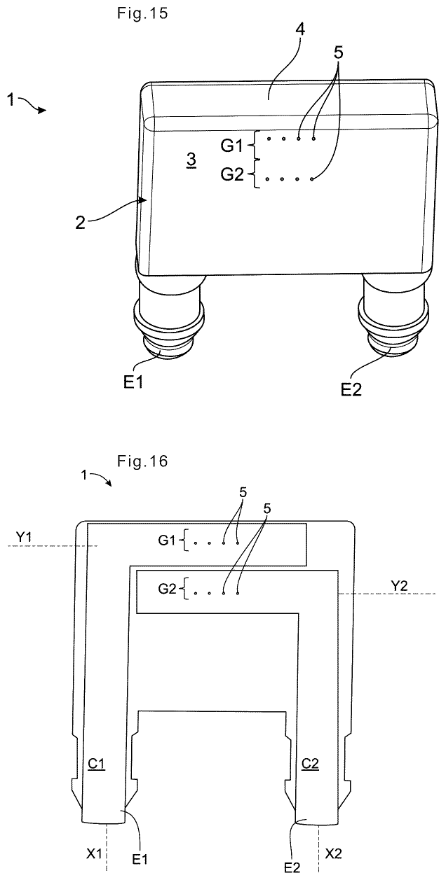

The use of a nozzle 1 according to a second variant embodiment of the invention, as shown in FIG. 15 and FIG. 16, makes it possible to no longer require the use of a large amount of cleaning liquid. To be specific, the entire glazed surface is cleaned each time the nozzle is activated, even if there is only a small dirty area to be cleaned on the glazed surface.

The use of a nozzle 1 according to the second variant embodiment of the invention, as shown in FIG. 15 and FIG. 16, also makes it possible to no longer waste cleaning liquid. To be specific, when the outside temperature drops, or when it is very windy, or when the vehicle is traveling at high speed, the jet tends to be deflected and spray an area located next to the glazed surface.

In these figures, the nozzle 1 used has several inlets E1, E2 for cleaning liquid, each inlet E1, E2 being connected to a cleaning liquid circulation channel which leads into the spray head 2 of the nozzle 1.

In the example shown, there are two channels C1 and C2. There could be more within the framework of the present invention.

Thus, the first channel C1 starts at the first inlet E1, and the channel C2 starts at the second inlet E2.

These liquid inlets E1, E2 correspond to hydraulic connections, suitable for connection to valves.

The channels C1, C2 have a first portion extending in a first direction X1, X2, then a second portion extending in a second direction Y1, Y2 perpendicular to the first direction X1, X2.

Other channel paths and orientations are within the scope of the present invention.

Holes 5 are made in the spray head 2, more specifically in a spray wall 3, and open into the channels C1, C2, at the end of the channels, in their second portions.

In the example shown, four holes 5 open into the first channel C1, and four holes 5 open into the second channel C2.

These holes are aligned along axes Y1 and Y2, but they could have another spatial distribution, as long as they open into the corresponding channel.

The nozzle 1 shown thus comprises a first group G1 of four holes 5 emerging from the first channel C1, and a second group G2 of four holes 5 emerging from the second channel C2.

There are as many groups of holes as there are channels.

When cleaning liquid is injected into the inlet E1 of the nozzle 1, four jets will exit through the four holes 5 of the group G1.

When cleaning liquid is injected into the inlet E2 of the nozzle 1, four jets will exit through the four holes 5 of the group G2.

The holes 5 have a uniform section.

Preferably, the holes 5 are cylindrical, and therefore have a circular section.

However, they could have a square or rectangular section.

There is no deflection surface in the spray head, or spout or anvil, as in the prior art. The holes 5 are simple.

These simple holes 5 make it possible to obtain a straight jet at the outlet, meaning that its projection corresponds only to a point, as shown in FIG. 6.

Such a straight jet cannot sweep the entire width of a glazed surface of a detection device, unless the glazed surface is very small. However, with such a straight jet, the pressure is greater at the point of impact, compared to a conical or flat jet. This type of straight jet therefore allows for better cleaning of dirty surfaces at the precise location where it strikes them.

Thus, instead of having a single jet that must cover the entire glazed surface, there are several jets that reach several areas of the glazed surface, so that ultimately cleaning fluid is spread over the entire surface.

According to this variant embodiment of the invention, the holes 5 have a diameter of less than 300 μm. These holes are therefore small compared to the prior art.

Preferably, the holes have a diameter of between 50 μm and 250 μm.

The smaller the passage section of the hole 5, the more the fluid speed increases for the same volume flow rate. By virtue of this higher fluid speed (i.e. the speed of interaction with the surface), the impact pressure will be greater at the point of impact on the glazed surface, compared to the prior art.

This also allows for precision regarding the point of impact on the surface to be cleaned.

The holes 5 are so small that the sum of their sections is still smaller than the section of a dispensing port according to the prior art.

With these small holes, it follows that the consumption of liquid product required for cleaning is lower compared to the prior art. In fact, consumption drops by at least 40%, and up to 60% with a nozzle according to this variant of the invention compared to a nozzle according to the prior art, while maintaining the same percentage of coverage of the cleaned surface.

Each hole 5 has a specific angular orientation relative to the spray wall 3, such that the jet exiting same points toward a specific area of the vehicle.

For example, a hole may be perpendicular to the spray wall 3 and thus send a jet perpendicular to the spray wall 3, or it may be oblique to the spray wall 3 and thus send a jet oriented to the right, or to the left, and/or to the front or to the rear of the spray head 2.

The angles are chosen as a function of the area to be treated by the jet on the vehicle.

The vehicle comprises a hydraulic circuit for cleaning the glazed surface of a detection device fitted to the vehicle.

The cleaning liquid is stored in a tank 7. A pump 8 sucks up this liquid and injects it into a network of valves V arranged upstream of the nozzle 1 and connected to the inlets E of the nozzle 1.

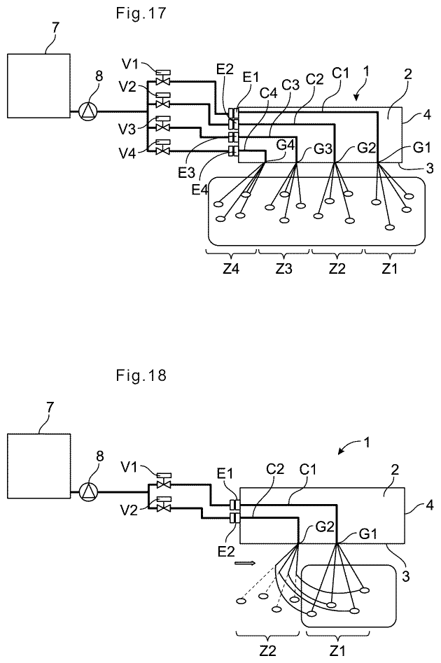

In the first configuration shown in FIG. 17, the nozzle 1 has four inlets E1, E2, E3, E4 connected to four valves V1, V2, V3, V4.

These inlets E1, E2, E3, E4 open onto four internal channels C1, C2, C3, C4 running inside the nozzle 1 and leading to groups G1, G2, G3, G4 of holes 5 through which jets exit when liquid is sent there. In other words, there are four pathways.

The holes 5 are made in the spray wall 3 which is arranged opposite a glazed surface of a detection device.

This glazed surface is divided into several areas Z1, Z2, Z3, Z4 to be cleaned.

There are as many channels as there are areas to be cleaned, and vice versa.

The areas are thus separated hydraulically by virtue of the plurality of pathways.

Thus, the holes 5 of the group G1 are oriented such that their jets reach the area Z1, and are distributed over this area Z1.

The same applies to the holes 5 of the groups G2, G3, G4 opposite the area Z2, Z3, Z4.

If the entire glazed surface is dirty, then all of the areas must be cleaned, and all of the valves will be opened to allow the cleaning liquid to pass through all of the pathways so as to spray the whole of the glazed surface.

If only one area is dirty, then only the valve corresponding to the group of holes oriented toward the area in question will be opened, the other valves will be closed. This makes it possible to avoid wasting liquid unnecessarily on areas that do not need to be cleaned.

If several areas are dirty, then the corresponding valves are opened, the other valves are closed.

As well as cleaning only the areas that are dirty, these areas are cleaned with several small high-impact jets, and therefore with a high cleaning efficiency.

In the second configuration shown in FIG. 18, the nozzle 1 has two inlets E1, E2 connected to two valves V1, V2.

These inlets E1, E2 open onto two internal channels C1, C2 running inside the nozzle 1 and leading to groups G1, G2 of holes 5 through which jets exit when liquid is sent there.

The holes 5 are made in the spray wall 3 which is arranged opposite a glazed surface of a detection device.

In this example, this glazed surface is not divided up, it corresponds to an area Z1 of the vehicle. It would be entirely possible to divide it as in the previous example.

A second area Z2 of the vehicle is located next to the area Z1. This could be an area of the bodywork for example, or any other part of the vehicle.

The holes 5 of the group G1 are oriented such that their jets reach the area Z1, and are distributed over this area Z1.

The holes 5 of the group G2 are oriented such that their jets reach the area Z2, and are distributed over this area Z2 (as shown by the dotted lines).

When the vehicle is stationary or traveling below a threshold speed, of the order of 70 km/h for example, and in the absence of wind, then only valve V1 will be opened and cleaning liquid will strike the area Z1 of the glazed surface to clean it if necessary.

When the vehicle is traveling above the threshold speed, or when it is very windy, then the jets exiting from the group of holes G1 are deflected by the aerodynamic flow or by the wind (illustrated by the arrow) and spray an area next to the glazed surface. Thus, the cleaning function does not work under these conditions, and the cleaning liquid is wasted if valve V1 is opened.

To overcome this problem, the holes 5 of the group G2 are oriented relative to the spray wall 3 such that their jets, which normally reach the area Z2 in the absence of wind or when the vehicle is traveling at a speed below the threshold value, reach the area Z1, being deflected by the aerodynamic flow or by the wind (as shown by the solid lines).

Thus, when the vehicle is traveling above the threshold speed, or when it is very windy, the valve V1 is closed while the valve V2 is opened and cleaning liquid will strike the area Z1 of the glazed surface to clean it if necessary.

It will be appreciated that depending on the position of the detection device on the vehicle, the aerodynamic impact will be different, and the orientation of the holes 5 will be adjusted accordingly beforehand.

The cleaning device comprises a central unit that receives input data from sensors, notably a vehicle speed sensor, or an anemometer, or a temperature sensor, which provides information on weather conditions or the speed at which the vehicle is traveling. Depending on these external parameters, and whether or not the glazed surface of the detection device needs to be cleaned, the central unit controls the pump and/or the valves, in order to activate the correct jets on the correct area to be cleaned.

The valves may correspond to solenoid valves controlled by the central unit. These are active valves, controlled via an electrical system.

The valves may also correspond to passive valves, which open or close as a function of the pressure of the cleaning liquid sent by the pump. For example, if the central unit commands the pump to send liquid to the valves at a pressure between 2 and 3 bar, then only the valve V1 opens, whereas if the pressure is between 3 and 4 bar, then only the valve V2 opens.

Such a choice of valve, active or passive, also applies to the first configuration presented above.

Whatever the configuration, the holes 5 are preferably arranged in the vicinity of the closed end 4 of the spray head 2. This is because only the spray head 2 protrudes from the vehicle body. The closer the holes 5 are to the closed end 4, the more it will be possible to hide part of the spray head 2 in the body. This applies to fixed nozzles in the body. The nozzles of the present invention may also be removable, in particular movable by translation, or telescopic in order to disappear under the hood.

The spray head 2 comprises at least one spray wall 3. The spray wall 3 is oriented toward the detection device to be cleaned located near the nozzle 1.

The spray head 2 could comprise several spray walls 3 if there are several glazed surfaces to be cleaned. It is possible to reduce the number of channels accordingly.

According to the present invention, whether the spray wall 3 is flat or curved, the angular orientation of the holes is chosen as explained above, oblique or perpendicular, depending on the position and extent of the target surface to be cleaned, the objective being to have a high rate of coverage of the surface to be cleaned.

Other shapes and other sections of spray heads may fall within the scope of the present invention, provided that the holes 5 make it possible to spray straight jets that reach the surface to be cleaned of the detection device.

The spray heads may advantageously be obtained by additive manufacturing, in order to obtain holes of very small section, rather than by drilling.

That said, any other manufacturing technique may be envisaged within the framework of the present invention.

The configurations shown in the cited figures are merely some possible and non-limiting examples of the invention, which by contrast incorporates form and design variants within the scope of the person skilled in the art.

What is claimed is:

1. A cleaning device for a glazed surface of a detection device fitted to a vehicle, comprising a nozzle supplied with liquid cleaning product, and having a spray head diffusing the liquid in the form of a jet, the spray head having a closed end,
wherein the spray head includes at least one spray wall provided with at least one hole through which a straight jet exits.

2. The device as claimed in claim 1, wherein the hole has a diameter of between 50 and 250 μm.

3. The device as claimed in claim 1, wherein the spray wall has a plurality of holes distributed spatially such that jets from the plurality of holes cover most of the glazed surface to be cleaned.

4. The device as claimed in claim 1, wherein the spray wall has a plurality of holes distributed uniformly.

5. The device as claimed in claim 1, wherein the spray wall is oriented perpendicular or obliquely to the closed end.

6. The device as claimed in claim 1, wherein the closed end consists of a spray wall.

7. The device as claimed in claim 1, wherein the spray wall is flat or curved.

8. The device as claimed in claim 1, wherein the spray head includes at least one spray wall provided with at least a first type of hole through which an impact jet exits, and at least a second type of hole through which a rinsing jet exits, the section of the hole of the first type being smaller than the section of the hole of the second type, the maximum diameter of the holes of the second type being less than 250 μm.

9. The device as claimed in claim 8, wherein the spray wall has a plurality of holes of the first type distributed spatially on the spray wall such that their jets strike various areas of the glazed surface.

10. The device as claimed in claim 8, wherein the flow rate of liquid passing through a hole of the first type is lower than the flow rate of liquid passing through a hole of the second type.

11. The device as claimed in claim 1, wherein all of the holes are oriented perpendicular to the spray wall, the resulting straight jets being perpendicular to the spray wall.

12. The device as claimed in claim 1, wherein all of the holes are oriented obliquely to the spray wall, the resulting straight jets being oblique to the spray wall.

13. The device as claimed in claim 1, wherein some of the holes are oriented perpendicular to the spray wall, and the other holes are oriented obliquely to the spray wall.

14. The device as claimed in claim 1, wherein the spray head includes at least one spray wall provided with holes through which jets exit, these holes being distributed in groups, each group includes one or more holes from which the jets reach a predefined area of the vehicle, the nozzle having as many liquid circulation channels as there are groups, each channel opening into a group of holes, the channel being connected to valves allowing the passage of liquid selectively through a single channel or through several.

15. The device as claimed in claim 11, wherein the valves are connected to a pump, the device further comprising a central unit controlling the pump and/or the valves according to input data, such as vehicle speed or outside temperature.
